(19) United States
(12) Patent Application Publication
(10) Pub. No.: US 2021/0187570 A1
(43) Pub. Date: Jun. 24, 2021

(54) DRAIN SNAKE DRILL WITH INTERCHANGABLE DRUMS

(71) Applicant: Daniel Jacob Ulloa, Port Charlotte, FL (US)

(72) Inventor: Daniel Jacob Ulloa, Port Charlotte, FL (US)

(21) Appl. No.: 17/108,803

(22) Filed: Dec. 1, 2020

Related U.S. Application Data
(60) Provisional application No. 62/952,583, filed on Dec. 23, 2019.

(51) Int. Cl. B08B 9/045; B23B 45/00; A46B 13/02; A46B 13/00; A46B 5/00

(52) U.S. Cl. CPC B08B 9/045; B23B 45/003; A46B 2200/3013; A46B 13/001; A46B 5/0037; A46B 13/02

(57) ABSTRACT

A drain snake drill includes an elongate body having a bore extending along its length to guide a cable snake. The body is open at its rear end to define a compartment space defined by a receptacle feature. A cable drum cartridge unit is installed in the rear compartment and includes a front opening through which a cable loaded into the drum cartridge unit can be dispended into the bore guide. The cartridge unit is interchangeable and can be exchanged for another one with a different snake cable length. A rotary motor drive unit is mounted to the drill body behind the installed cartridge unit. The motor drive unit engages the loaded, coiled snake cable in a rotary action that induces the cable to unwind and travel through the bore guide where it is dispensed from the drill for cleaning purposes.

### FIELD OF THE INVENTION

The present invention relates generally to drain snakes, and more particularly, to a drill tool that offers variable length cables using interchangeable cable drums selectively fitted to the drill, which advances and retracts the drain snake in a controlled operation.

### BACKGROUND OF THE INVENTION

Heating, ventilation, and air conditioning (HVAC) units are critical components of most buildings. They are necessary to maintain proper environmental comfort for any specific reason—be it for a storage unit, a laboratory running experiments, or just someone's home. The United States alone uses more air conditioning than all other nations, with 84% of all homes containing some form of air conditioning.

The machinery resembling the modern HVAC originated in the early 1900s. These units were extremely costly which only the wealthiest could afford to purchase. As the technology improved and became more accessible, its downsides also became widely apparent. For one, repair requiring new, undamaged parts were constantly in demand and often costly. In addition, maintenance of the technology was mostly delegated to technicians familiar with its inner workings, as fear of damages prevented many of its owners from conducting the necessary upkeep. In fact, 42% of homeowners call professionals for routine maintenance on their HVAC, while the rest do not participate in its conservation.

One universal problem with these units is the susceptibility to clogging, especially within its condensate pipe. HVAC condensate pipes may clog for various reasons, be it environmental debris, algae growth due to moisture build-up, or other less common causes. The effects of the clogs can range from elevated humidity inside a home, the permeation of musty odor, and to potentially costly water damage throughout the facility. If the HVAC is connected to a main drain line that joins multiple units in a condominium, the problems intensify, as its effect becomes much more widespread and expenses likely skyrocket.

Part of the accessibility of these units emerged from the ways in which its maintenance became more practical, but are unfortunately still far from perfect. Suppose the condensate pipe clog is substantial due to the lack of awareness by the owners of the facility to upkeep the unit on a regular basis—this example is a rather common occurrence. Upon calling a technician to care for the problem, a vacuum may be used to suck whatever debris is preventing the pipe from performing its function adequately. This may not work since the clog may be stuck too firmly to the pipe to be susceptible to the vacuum's power output.

To treat the drawbacks of using a vacuum, an air compressor usually has more than enough power to rid the pipe of debris. Unfortunately, this method may potentially lead to the damaging or bursting of the pipes along its entire foundation, affecting the walls in which it runs through and introducing a threat to the safety of the inhabitants. Utilizing solvents can temporarily alleviate the problem, but not without damage to the inside of the pipe, eventually leading to its complete deterioration. This latter process is also time consuming, wasting about 15-20 minutes of the technician's time waiting for the solvent to chew through the debris.

Therefore, a solution that makes it more reasonable and accessible for homeowners to perform the maintenance while simultaneously allowing technicians to be more efficient with their time is largely in need. Some solutions that are available perform its intended function, but not without major drawbacks that can be resolved with a unique design.

Accordingly, there is an established need for a drain snake drill capable of accommodating variable length snake cables.

### SUMMARY OF THE INVENTION

The present invention is directed to an electric powered, drain snake drill. The drill includes an elongate body and a column-type handle extending downward from the body, equipping the drill for hand-held use. The body has a front end, a rear end, and a bore-type barrel guide extending between the front end and the rear end. The body includes an open-ended receptacle formed at its rear end. The receptacle includes a front opening and a rear opening and defines a compartment space. The front opening of the receptacle is disposed in communication with the barrel guide. A cartridge drum unit can be selectively installed in the compartment space of the receptacle. The drum unit includes a drum and a snake cable loaded inside the drum, such as in a coiled, conical spiral configuration. The drum unit includes a front aperture defining a cable feed port that is disposed in communication with the front opening of the receptacle during installation. The drum unit further includes an open, rear end providing access to the snake cable loaded inside the drum. A detachable rotary drive motor unit is mounted to the body at its rear end and coupled to the cartridge drum unit. The motor unit is configured to apply a rotary driving action to the cable to induce passage of the cable through the cable feed port, either in an uncoiling operation (cable advances or unwinds) or a coiling operation (cable retracts or winds). The motor unit can be detached from the drill body to permit another drum to be installed having a different cable length, customizing the drill to the plumbing application. The motor unit is a universal driving tool that can be used with any of the interchangeable drum units. The drill can be equipped with various control features and settings to permit the user to select the appropriate operating mode.

Introducing a first embodiment of the invention, the present invention consists of a drain snake drill, comprising:

an elongate body having a front end, a rear end, and a bore guide extending between the front end and the rear end of the body;

a receptacle formed at the rear end of the body and including a front opening and a rear opening, the front opening disposed in communication with the bore guide, the receptacle defining a compartment space;

a cartridge drum unit selectively removably installed in the compartment space, the drum unit including a drum, a cable loaded inside the drum, and a cable feed port in communication with the front opening of the receptacle; and

a rotary driving tool disposed at the rear end of the body proximate the cartridge drum unit and configured to apply a rotary driving action to the cable to induce a selectively controllable bidirectional translation of the cable through the cable feed port and bore guide.

In a second aspect, the rotary driving tool is selectively attachable to, and detachable from, the body at the rear end thereof.

In another aspect, the rotary driving tool includes a motor drive unit.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a front perspective view showing a first embodiment of the drain snake drill of the present invention;

FIG. 2 presents a front perspective, exploded view of the first embodiment of the drain snake drill of the present invention;

FIG. 3 presents a front perspective view of the first embodiment of the drain snake drill of the present invention, illustrating further advancement of the snake cable relative to its partially advanced position depicted in FIG. 1;

FIG. 4 presents a front perspective view of the first embodiment of the drain snake drill of the present invention, illustrating full retraction of the snake cable into the drill; and

FIG. 5 presents a cross-sectional, partially diagrammatic, side view of the first embodiment of the drain snake drill of the present invention, taken along the longitudinal plane 5-5 in FIG. 1;

FIG. 6 presents an enlarged section view of the first embodiment of the drain snake drill of the present invention, expanding the section marked 6 in FIG. 5;

FIG. 7 presents a partial, fragmented rear perspective view of the first embodiment of the drain snake drill of the present invention, illustrating the mounting process for coupling the detached motor unit to the installed cable drum unit;

FIG. 8 presents a partial, fragmented side view of the first embodiment of the drain snake drill of the present invention, illustrating how the cleaning head penetrates a pipe during advancement of the drain snake; and

FIG. 9 presents a partial, fragmented top diagrammatic view of the first embodiment of the drain snake drill of the present invention, illustrating how the drain snake and accompanying cleaning head attachment are able to navigate a series of curved pipe sections.

Like reference numerals refer to like parts throughout the several views of the drawings.

### DETAILED DESCRIPTION

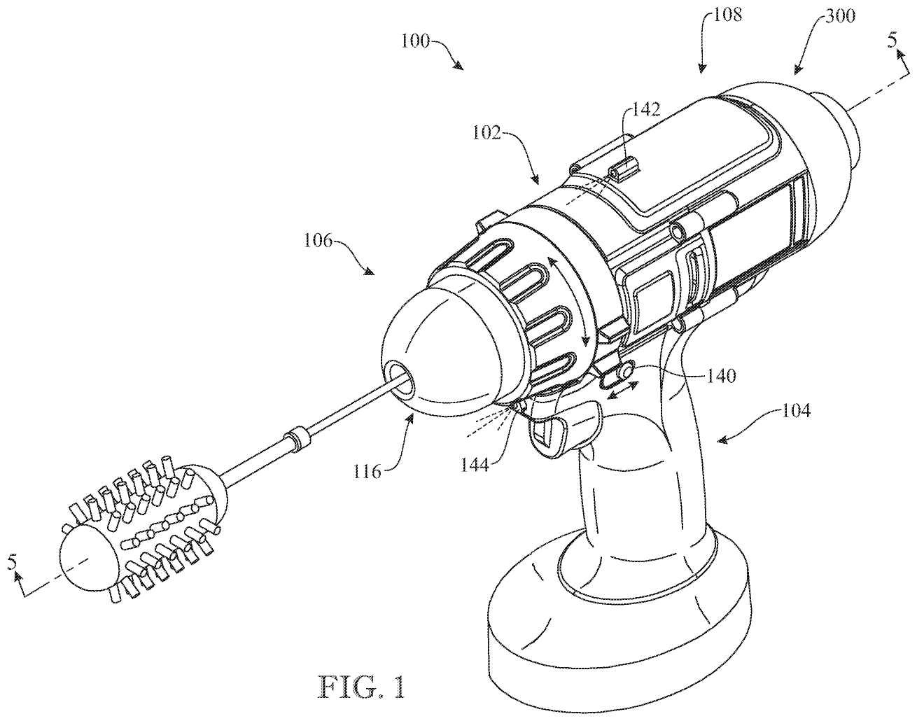

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward an electric powered, drain snake drill adapted to support installation of a removable drum unit pre-loaded with a snake cable. A detachable motor drive unit is configured to power movement of the cable. The drain snake drill permits interchangeable drum units having variable length cables to be used in the drill.

Referring initially to FIGS. 1, 2, 5 and 6, a drain snake drill 100 is provided in the form of a portable, hand-held tool including a body 102 and a handle 104 extending downwardly from body 102. The drain snake drill 100 further includes a modular, removable cable drum cartridge unit 200 and a detachable motor unit 300. As discussed further, the body 102 is adapted at a back end to receive cable drum cartridge unit 200, which in turn is powered by motor unit 300 mounted behind the installed cartridge unit 200. Following installation, when cable drum cartridge 200 is installed in body 102 and motor unit 300 is mounted to body 102 in driving relationship to cable drum cartridge 200, the drain snake drill 100 operates to dispense a snake cable 202 loaded into cable drum cartridge 200, in order to facilitate a pipe cleaning operation. The cable drum unit 200 is considered a fungible or interchangeable resource because it can be swapped out or exchanged (substituted) for another such drum unit 200 loaded with a different sized snake cable 202, making the drain snake drill 100 adaptable to a variety of plumbing applications requiring different-length cable snakes. In this manner, the cable drum unit 200 forms a cartridge-type device.

The body 102 has an elongate, generally cylindrical shape having a front, cable-dispensing end 106 and a rear, cartridge-loading end 108. In one form, the body 102 has a generally reduced radius tapering from rear end 108 to front end 106. The body 102 includes a generally central, cable-guiding barrel or interior guide 110 that extends between the front end 106 and the rear end 108 of body 102. The guide 110 has a hollow, bore-type configuration that guides and supports the passage of snake cable 202 through it, in either direction. The guide 110 has a front, generally circular opening or mouth 112 and a rear, generally circular opening or mouth 114. The guide 110 extends axially between its front opening 112 and rear opening 114. The front opening 112 of guide 110 forms the forward-most section of the front end 106 of body 102. The body 102 has the functionality and configuration of a housing or case. The leading section of the front end 106 of body 102 forms a drill head 116.

The rear end 106 of body 102 includes an open-ended receptacle feature 126 adapted to receive and house cable drum cartridge unit 200. In this manner, the receptacle feature 126 has a female-type functionality, while the drum cartridge unit 200 has a male-type functionality. The receptacle feature 126 defines a cartridge-receiving compartment space or chamber 120 that permits drum cartridge unit 200 to be rear end loaded into drill 100 by insertion into space 120. The receptacle feature 126 is located immediately behind, and in communication with, the bore-type cable guide 110. In one form, the receptacle feature 126 has a generally concave, dome-type shape to accommodate a similar shape of cable drum unit 200. The receptacle feature 126 includes a front opening 122 (disposed opposite and in communication with the rear opening 114 of guide 110) and a rear opening 124, which forms a mouth-like feature defining the rear terminus of body 102. In its exemplary concave form, receptacle 126 extends, in a hemispherical shape or profile, from its front opening 122 to its rear opening 124. During assembly, the cable drum cartridge unit 200 is loaded into compartment 120 through rear opening 124. In this manner, the compartment 120 serves as a loading chamber or cartridge holding area into which the cable drum unit 200 is placed and situated during installation and subsequent drill operation.

The bore-type cable guide 110 and cartridge-receiving receptacle feature 126 are arranged in an integral, adjacent relationship to one another so that the compartment space 120 (defined by receptacle feature 126) is in communication with the hollow space defined by cable guide 110. In this manner, the combination of bore-type cable guide 110 and the compartment space 120 defined by receptacle feature 126 forms a type of breech-loader in which the cartridge-type drum unit 200 is inserted or loaded into a chamber (compartment space 120) that is integral to the rear portion of the barrel-type feature defined by cable guide 110. The receptacle feature 126 immediately transitions to cable guide 110, so that snake cable 202 loaded into drum cartridge unit 200 can be moved directly into cable guide 110 for further guiding and eventual dispensing from drain snake drill 100 via front opening 112 of guide 110. The immediate transition from compartment space 120 to cable guide 110 occurs at the interface between front opening 122 of receptacle feature 126 and the coextensive rear opening 114 of cable guide 110. In one form, this transition between receptacle feature 126 and cable guide 110 defines a continuous throat area integrally connecting these structures together.

The cable drum cartridge unit 200 includes a container or drum 204 having a dome-type shell or body 210 adapted to house snake cable 202 and from which snake cable 202 can be dispensed and then returned. The body 210 of drum 204 defines an open-ended compartment space to receive and hold snake cable 202. The drum 204 includes a front opening 206 and a rear opening 208 providing access to the snake cable 202 loaded inside the drum 204. The front opening 206 of drum 204 defines a cable feed port through which cable 202 can pass or travel from its location inside drum 204.

The snake cable 202 can take a variety of forms in its loaded (wound) condition in drum 204. Generally, the wound snake cable 202 has a configuration that facilitates ease of unwinding and winding. In particular, the snake cable 202 is preferably wound in a manner that promotes ease of unwinding (cable dispensing) and winding (cable retraction). The loaded snake cable 202 can have a helix or spiral configuration in its packed condition. Other suitable winding configurations are possible for snake cable 202. One exemplary winding configuration is a conical spiral. For this purpose, in order to accommodate the placement of cable 202 having such a conical spiral shape, body 210 of drum 204 tapers in a progressively wider cross-section from its front opening 206 to its rear opening 208. In an exemplary form, the body 210 of drum 204 can have a concave shape, such as a hemispherical profile.

During assembly, the cable drum unit 200 is loaded into the compartment space 120 of receptacle feature 126 at the rear end 108 of body 102. The cable drum unit 200 is oriented for installation by positioning the narrow end proximate front opening 206 as the leading nose that first enters compartment space 120. In order to facilitate this placement, the shape of receptacle 126 (defining the rear end compartment space 120 of body 102) is made to accommodate the shape of drum container 204 of cable drum cartridge unit 200, so that cable drum cartridge unit 200 can be loaded or inserted into compartment 120 in a nesting relationship. The installation of cable drum cartridge 200 into compartment 120 (at the rear end 108 of body 102 of drain snake drill 100) produces an alignment of front opening 206 of drum 204 of cable drum cartridge unit 200 with front opening 122 of receptacle feature 126. Since the front opening 122 of receptacle feature 126 is aligned with the rear opening 114 of barrel guide 110, the front opening 206 of drum 204 of cartridge unit 200 is likewise aligned with rear opening 114 of barrel guide 110. In this manner, snake cable 202 is able to be unwound from its packed location in drum 204 and directly maneuvered into barrel guide 110. During this maneuvering, cable 202 uncoils and exits drum container 204 via its front opening 206, where it passes into the rearmost end of cable guide 110 via its rear opening 114.

Referring still to FIGS. 1, 2, 5 and 6, motor unit 300 is configured as a rotary driving mechanism that mounts to the rear end 108 of drill body 102 immediately behind the installed cable drum cartridge unit 200. In this mounted position, motor unit 300 applies a rotary driving action to snake cable 202 that induces it to selectively unwind (wind) from its coiled (uncoiled) condition. Motor unit 300 includes, in combination, a drive motor 302, driven shaft 304 connected to drive motor 302, and a driven rotary coupling device 306 connected at an input end to shaft 304 and coupled at an output end to snake cable 202 loaded inside cable drum cartridge unit 200. The drive motor 302 rotates shaft 304, which in turn rotates coupling device 306. The rotation of coupling device 306, by virtue of its driving connection to snake cable 202, causes the snake cable 202 to uncoil or unwind in response to a first direction of rotation (e.g., clockwise) and causes the snake cable 202 to coil or wind in response to a second direction of rotation opposite to the first (e.g., counterclockwise). The rotary power applied by coupling device 306 to snake cable 202 impels the snake cable 202 to undergo both a translation (forward or reverse motion) and a rotation. The forward translational movement works to dispense snake cable 202 from drill 100 (via guide 110) and advance it through a pipe designated for cleaning, while the reverse translational movement works to retract the snake cable 202 once the cleaning operation is finished and to return it to its storage location in drum 204 in a wound, coiled condition. The rotational movement imparted to snake cable 202, concurrent with its translation, facilitates the cleaning operation due to the boring effect created when a bristle attachment 400 adapted for connection to the leading end of snake cable 202 is made to rotate.

Any type of suitable motor unit 300 can be used to provide the needed driving action to uncoil and drive snake cable 202. In one form, motor unit 300 includes a housing 310 constructed as a dome-like or hemispherical capsule including a dome shell 312 and a generally circular, planar end face, cover or lid 314 mounted to dome shell 312 to form an interior enclosure space 316. The drive motor 302 is supported and carried by housing 310 at a general apex section of dome shell 312. The driven shaft 304 extends from drive motor 302 in an axial direction generally coincident and aligned with the longitudinal axis of cable guide 110 in drain snake drill 100, once motor unit 300 is mounted to drill 100 behind the installed drum cartridge unit 200. In this manner, the driving action developed by the combination of driven shaft 304 and coupling device 306 engages snake cable 202 and imparts a motive effect that appropriately guides snake cable 202 through guide 110. The drive motor 302 and driven shaft 304 are suitably configured, in a manner well known to those skilled in the art, to enable the drive motor 302 to rotate shaft 304 in a controlled operation.

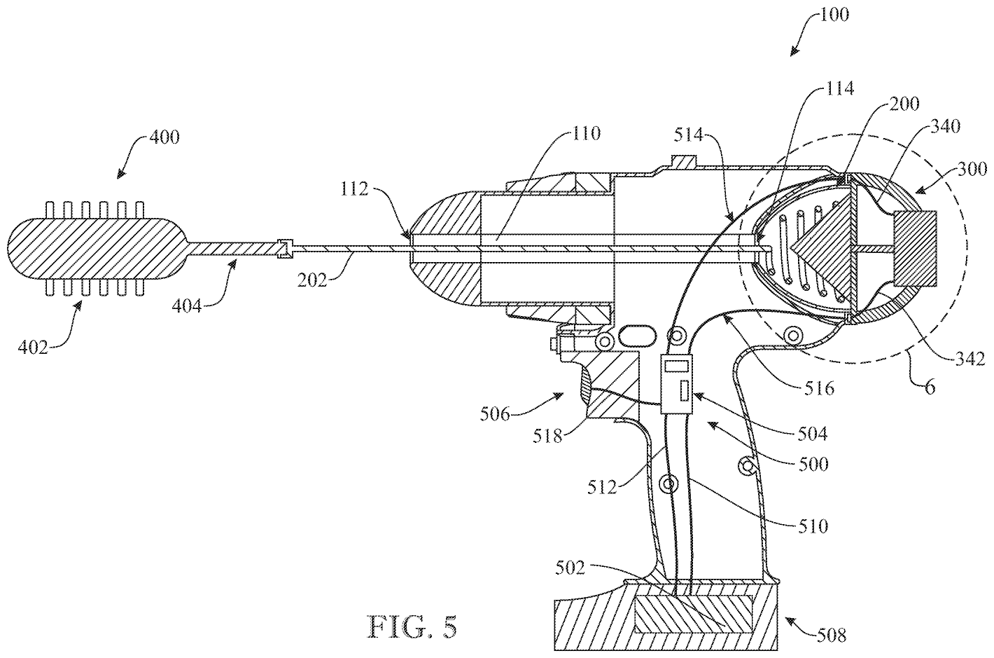

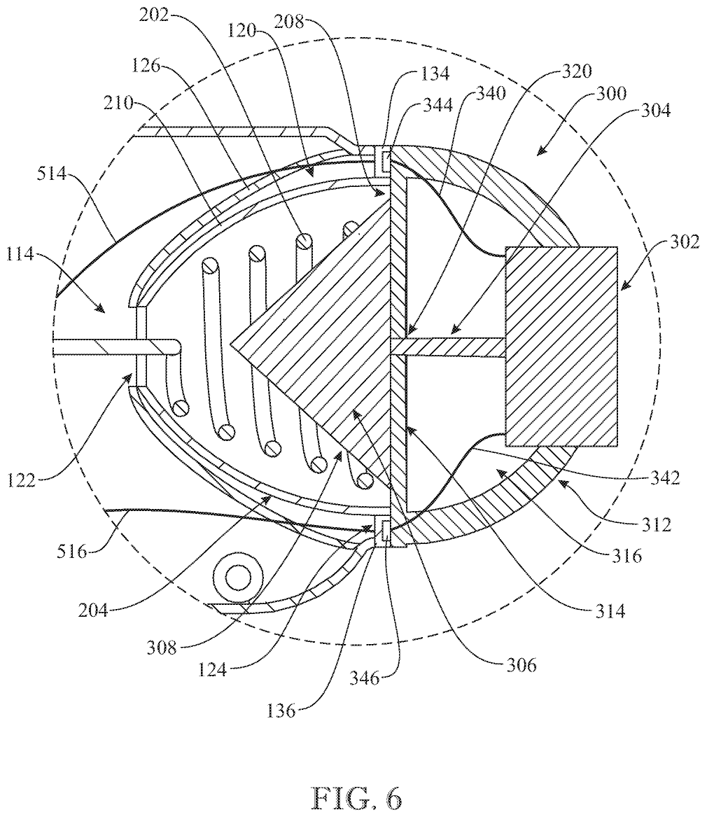

The coupling device 306 of motor unit 300 is adapted for concurrent rotation with the rotation of shaft 304. For this purpose, shaft 304 extends through an opening 320 formed in face 314 of housing 310 and connects at an output end to coupling device 306. The coupling device 306 is configured to suitably engage and induce an uncoiling (coiling) of snake cable 202 in response to rotation of coupling device 306. In one form, coupling device 306 has the shape of a cone in conformity with the conical spiral configuration of snake cable 202. The output end of shaft 304 (distal from its input end directly powered by drive motor 302) is connected to the base of cone-shaped coupling device 306, which is mounted to face 314 of housing 310 of motor unit 300. In the assembled configuration depicted in FIGS. 5 and 6, when the drum cartridge unit 200 is loaded into the rear end of drill 100 and motor unit 300 is mounted behind drum cartridge unit 200, the rotary coupling device 306 is located within the interior of the wound snake cable 202. In this position, the exterior sloped surface 308 of rotary coupling device 306 is disposed in opposing, facing engagement with the windings of snake cable 202. As drive motor 302 operates and drives shaft 304 into rotation, this rotational activity is coupled or transferred via coupling device 306 to snake cable 202.

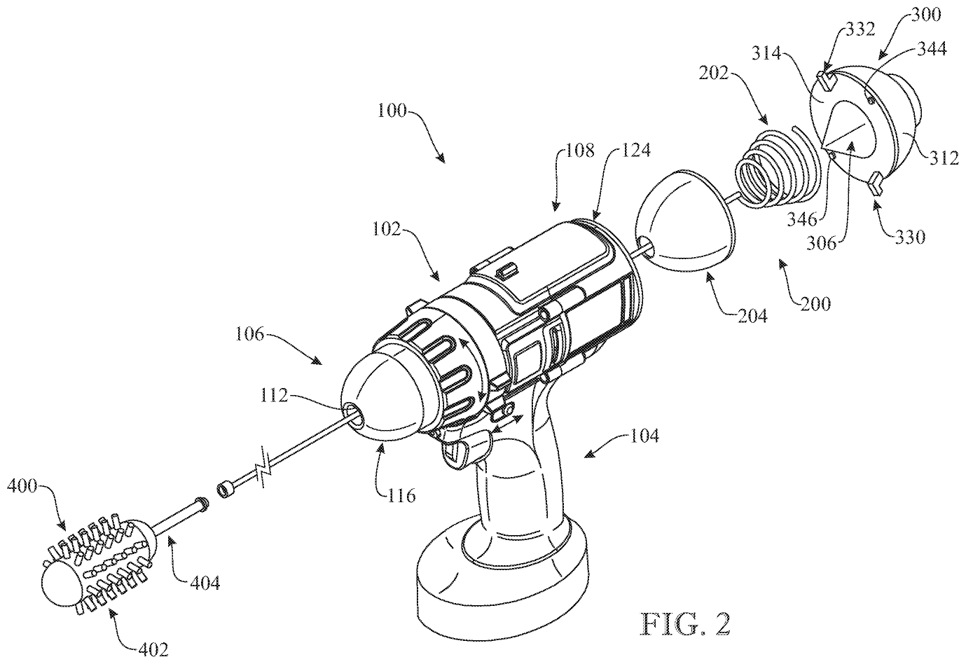

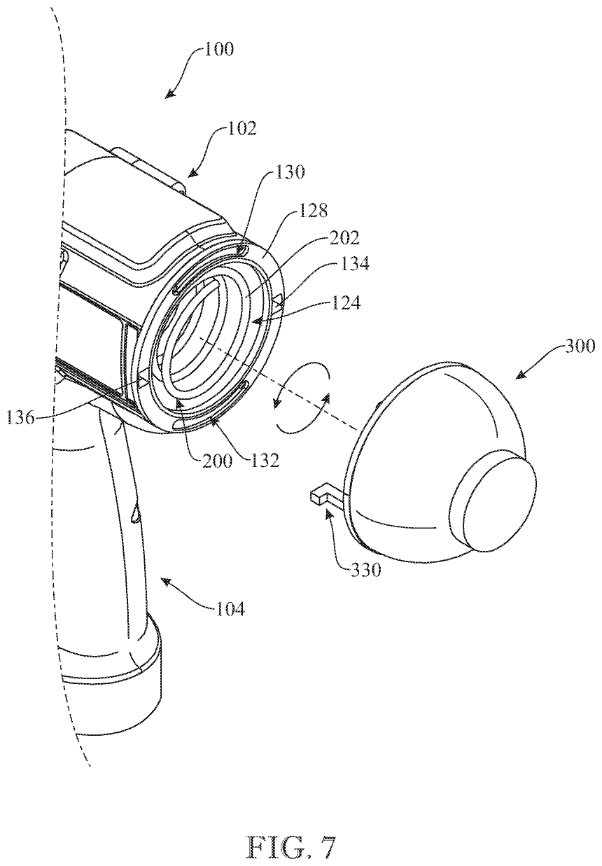

Referring now to FIGS. 2 and 7, any suitable means can be used to removably attach motor unit 300 to the body 102 of drill 100 at its rear end 108, so that motor unit 300 is in appropriate driving relationship to snake cable 202 loaded into the installed drum cartridge unit 200. In one exemplary arrangement, motor unit 300 is fitted with a pair of diametrically opposite, L-shaped male projections or fittings 330, 332 that are insertable and receivable within a corresponding pair of female slots 130, 132 formed in a rear peripheral surface of body 102 of drill 100. The male projections 330, 332 each have a first section extending axially from a peripheral edge of face 314 of housing 310 of motor unit 300, and a second section extending radially outward from the first section. The female slots 130, 132 each extend for a length in a circumferential direction. During assembly, cartridge unit 200 is installed in drill 100 at its rear end 108 (FIG. 7). The motor unit 300 is then mounted to body 102 of drill 100 by aligning male projections 330, 332 (of motor unit 300) with female slots 130, 132 (of drill body 100). The male projections 330, 332 are inserted into the female slots 130, 132 and then motor unit 300 is turned to enable the male projections 330, 332 to slide through female slots 130, 132 until the male projections 330, 332 are temporarily seated in a suitable catch or latch formed in female slots 130, 132. The engagement between male projections 330, 332 and female slots 130, 132 is adapted to enable a temporary lock between motor unit 300 and the body 102 of snake drill 100. The female slots 130, 132 are suitably configured to receive the male projections 330, 332.

Referring now to FIGS. 5 and 6, an electrical circuit generally illustrated at 500 controls the operation of drill 100. The circuit 500 includes a battery 502, a controller 504, and a user-activated switch 506. The battery 502 is carried by a removable base 508 attached to a lower end of handle 104, forming a rechargeable battery pack. In one exemplary arrangement, controller 504 functions to route input power signals from battery 502 (on electrical lines 510, 512) to drive motor 302 of motor unit 300 (on electrical lines 514, 516) in response to control signals received from switch 506 (on control line 518). The power lines 340, 342 of drive motor 302 of motor unit 300 are connected to the output electrical lines 514, 516 of controller 504 of circuit 500 by a temporary connection, as discussed further. In motor unit 300, a periphery of face 314 of housing 310 includes a pair of exposed, diametrically opposite electrical contacts 344, 346 (FIGS. 2 and 6). These electrical contacts 344, 346 are electrically connected to power lines 340, 342 of drive motor 302. In drill 100, at the rear peripheral surface 128 of body 102, a pair of diametrically opposite, recessed electrical terminals 134, 136 are formed (FIGS. 6 and 7). These electrical terminals 134, 136 are electrically connected to output electrical lines 514, 516 of controller 504 of circuit 500. During assembly, when motor unit 300 is mounted to the back end of drill 100, the electrical contacts 344, 346 of motor unit 300 are seated in recessed electrical terminals 134, 136 of drill 100, establishing a secure electrical connection between controller 504 and drive motor 302. This temporary electrical connection is interrupted when motor unit 300 is removed.

The drill 100 can be equipped with various controls and settings to direct and support its operation. For example, drill 100 can include a setting 140 to select the direction of rotation of the unwinding snake cable 202 (FIG. 2). Additionally, drill 100 can be equipped with a set of light sources 142, 144 disposed at appropriate locations on body 102 and/or handle 104 of drill 100 to enhance viewing, especially in enclosed operating environments lacking accessible illumination. It should be apparent to those skilled in the art than these optional controls and settings can be readily integrated into electrical circuit 500. Optionally, the front end 106 of drill 100 (at drill head 116) can incorporate a twist feature to facilitate the forward and reverse motion of snake cable 202. Alternately, this functionality can be performed with a thumb switch for right and left-handed persons gripping handle 104, such as a click-type switch using an up-down setting to make a selection.

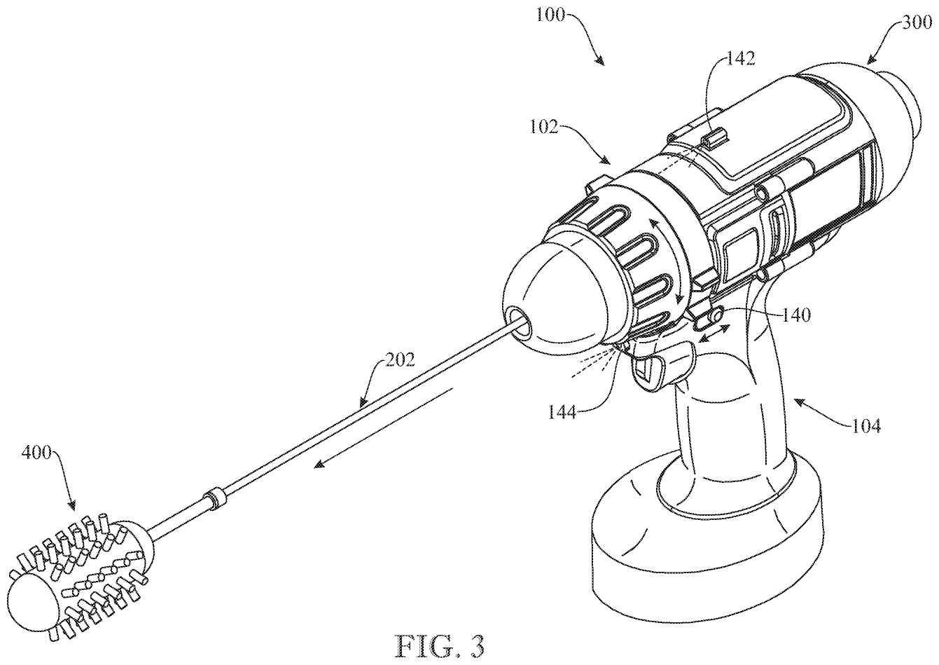

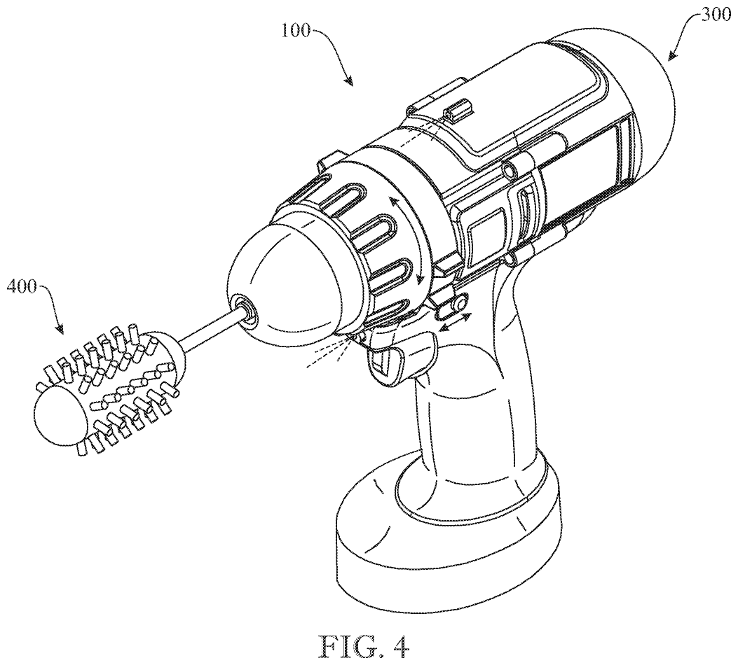

Referring now to FIGS. 3, 4, 8 and 9, in operation, cartridge unit 200 is installed in drill 100 and motor unit 300 is mounted behind cartridge unit 200. The leading end of snake cable 202 is adapted in any suitable manner to accommodate the temporary attachment of a removable cleaning tool such as a bristle attachment 400. The bristle attachment 400, for example, can include a bristled head 402 and an adapter or attachment arm 404 extending from head 402 and removably attachable to, and detachable from, snake cable 202 (FIGS. 2 and 5). The removable connection between bristle attachment 400 and snake cable 202 can be realized in any suitable conventional manner, such as a snap-fit or screw-type fitting. The removable feature of bristle attachment 400 supports the use of various cleaning heads with different types of bristle schemes for different types of pipe blockages. In order to secure bristle attachment 400 to snake cable 202, snake cable 202 is dispensed an appropriate length so that bristle attachment 400 can be attached (FIG. 4).

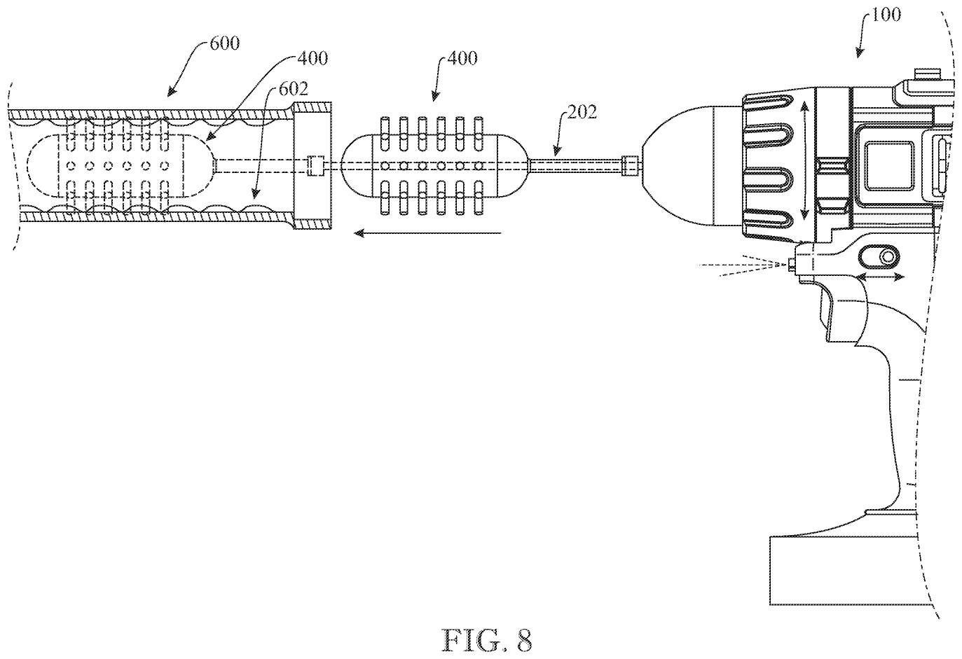

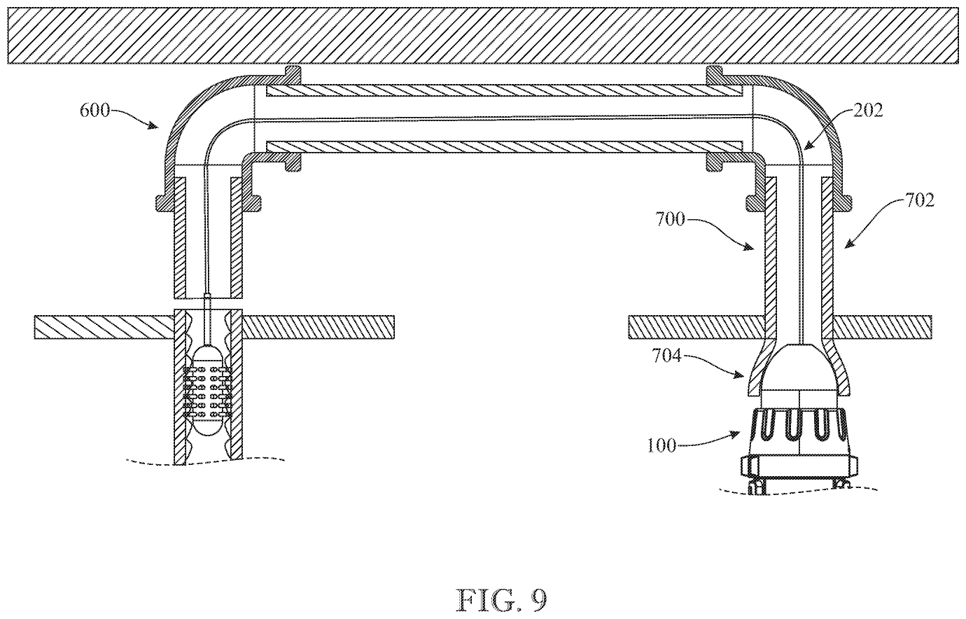

In operation, the fully assembled drill 100 (including cable drum cartridge unit 200 and motor unit 300), as fitted with bristle attachment 400, is suitably positioned at the entrance of a pipe section 600 where a cleaning operation is desired (FIG. 8). By suitable operation of drill 100, the snake cable 202 is advanced (FIGS. 3 and 8) so that it can travel through the pipe section 600 to reach the area of blockage. Due to the flexibility of snake cable 202, the drill 100 is able to navigate and route snake cable 202 through bends and curves in pipe section 600 (FIG. 9). As the cable 202 uncoils and spins during operation of drill 100, the bristle cleaning head 402 spins, cleaning the interior of pipe 600. For example, the bristles of cleaning head 402 scrub away material 602 (FIG. 8) located on the interior of pipe 600. After completion of the cleaning operation, snake cable 202 can be withdrawn from pipe section 600 and further retracted until it is recoiled in cable drum cartridge unit 200.

One optional feature includes an extender 700 that enables drill 100 to reach pipes that are difficult to access. The extender 700 includes a tube 702 having a flared mouth section 704 that conforms to the shape of drill head 116, so that the front end 106 of drill 100 can be seated to maintain a stable positioning of drill 100 during use. A leading end of tube 702 is smaller than pipe section 600 so that it can be inserted into pipe section 600 to ensure safe passage of snake cable 202 into pipe section 600. The extender 700 functions as a bridge to create a passageway for snake 202 to travel before it enters pipe section 600.

The interchangeable cable drum cartridge unit 200 may include cable lengths of any size, such as 5, 10, 15 or 25 ft., depending on the application. The configuration of the drum cartridge unit 200 is universal and would not change even as the length of the snake cable 202 loaded into drum container 204 changes. A snake cable 202 of longer length would simply be wound more compactly/tightly inside drum 204 than one of shorter length.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A drain snake drill, comprising:
an elongate body having a front end, a rear end, and a bore guide extending between the front end and the rear end of the body;
a receptacle formed at the rear end of the body and including a front opening and a rear opening, the front opening disposed in communication with the bore guide, the receptacle defining a compartment space;
a cartridge drum unit selectively removably installed in the compartment space, the drum unit including a drum, a cable loaded inside the drum, and a cable feed port in communication with the front opening of the receptacle; and
a rotary driving tool disposed at the rear end of the body proximate the cartridge drum unit and configured to apply a rotary driving action to the cable to induce a selectively controllable bidirectional translation of the cable through the cable feed port and bore guide.
